(19) United States
(12) Patent Application Publication
(10) Pub. No.: US 2025/0245232 A1
(43) Pub. Date: Jul. 31, 2025

(54) UNIQUE EXTENDABLE GROUP IDENTIFIERS FOR EFFICIENT AGGREGATION QUERY PROCESSING USING MULTIPLE GROUPING KEYS

(71) Applicant: Oracle International Corporation, Redwood Shores, CA (US)

(72) Inventors: Dennis Lui, Sunnyvale, CA (US); Weiwei Gong, Belmont, CA (US)

(21) Appl. No.: 18/427,642

(22) Filed: Jan. 30, 2024

(51) Int. Cl. G06F 16/2455; G06F 9/38; G06F 16/22; G06F 16/2453

(52) U.S. Cl. CPC G06F 16/24556; G06F 9/3887; G06F 16/2255; G06F 16/2453; G06F 16/2456

(57) ABSTRACT

Data structures and methods are described to provide a unique extendable group identifier for efficient aggregation query processing using multiple grouping keys. A method comprises retrieving a database query comprising an aggregate function of a selected column from a database table, grouped by a plurality of columns. The method further comprises maintaining a plurality of hash tables that map column values to grouping keys and identify a maximum grouping key. The method further comprises updating a plurality of bitmasks that define per-column grouping key bit positions, capable of storing the maximum grouping key, within a combined index value. The method further comprises allocating a result array sized according to the plurality of bitmasks. The method further comprises using the plurality of bitmasks and the plurality of hash tables to determine the combined index value to apply the aggregate function on the selected column for each row in the database table.

### FIELD OF THE INVENTION

The present disclosure relates to techniques for database aggregation queries. More specifically, the disclosure relates to providing a unique extendable group identifier for efficient aggregation query processing using multiple grouping keys.

### BACKGROUND

Aggregate functions are a common operation that is required of many data processing tasks, including database queries. Examples of aggregate functions include sum, count, average, minimum, and maximum. These aggregate functions are typically applied to specific groups identified by one or more column values, which can be translated into grouping keys.

In one approach, aggregation grouped by multiple column values is supported by decompressing, if necessary, the column values of a row, concatenating the column values together, and using the concatenated value as an input to a single hash table to retrieve and update the current aggregate result for the current row being processed. This approach has some drawbacks with regards to performance and memory utilization. For example, since the concatenated value requires decompressed column values, additional overhead is incurred if the columns are stored in a compressed format, such as dictionary compression. Further, the hash table lookup may require traversal of a complex data structure, thereby hindering parallelization of the aggregation function using single instruction, multiple data (SIMD) vector operations. Additionally, because the single hash table has to support potentially numerous combinations of concatenated values, the hash values need to be sized accordingly, thereby increasing memory footprint. Thus, an improved approach to support efficient aggregation query processing using multiple grouping keys is needed.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 is a block diagram that depicts an example database management system (DBMS) in which a unique extendable group identifier for efficient aggregation query processing using multiple grouping keys may be supported.

FIG. 2 depicts an example database table.

FIG. 3 depicts an example database query with an aggregate function using multiple grouping keys, and a corresponding query result.

FIG. 4A and FIG. 4B depict example aggregation metadata for supporting a unique extendable group identifier for efficient aggregation query processing using multiple grouping keys.

FIG. 5 is a block diagram that depicts generating a combined index value using bitmasks on row data to perform aggregation using multiple grouping keys.

FIG. 6 is a flow diagram that depicts an example process to perform an aggregation query using multiple grouping keys via a unique extendable group identifier.

FIG. 7 illustrates a block diagram of a computing device in which the example embodiment(s) of the present invention may be embodiment.

FIG. 8 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Data structures and methods are described for providing a unique extendable group identifier for efficient aggregation query processing using multiple grouping keys. A separate hash table is maintained for each group-by column, mapping column values to grouping keys. These grouping keys can be combined together using bitmasks to form a unique group identifier that is used as a direct index into an aggregation results array. The size of the grouping keys can be dynamically grown by maintaining a maximum grouping key for each column and updating the bitmasks and expanding the results array as needed to support the maximum grouping keys.

The use of a unique extendable group identifier provides several advantages over existing approaches. By using separate hash tables, each hash table only needs to be sized according to the cardinality of each grouping column, thereby reducing memory footprint. By allowing the grouping keys to grow dynamically in size, memory footprint can be minimized while still supporting database tables having grouping columns of unknown cardinality that can grow in size during query processing. Since the compressed columnar data can be used directly as the keys for each hash table, decompression overhead can also be bypassed that would otherwise be incurred when concatenating decompressed values for a single hash table.

Further, by storing the aggregation results in an array rather than a complex data structure such as a hash table, direct access to array elements is readily achieved, therefore facilitating SIMD processing of the aggregation functions. Thus, highly parallel computing architectures such as multi-core processors and graphics processing units can be leveraged to improve query performance and reduce latency.

### Example Database Management System

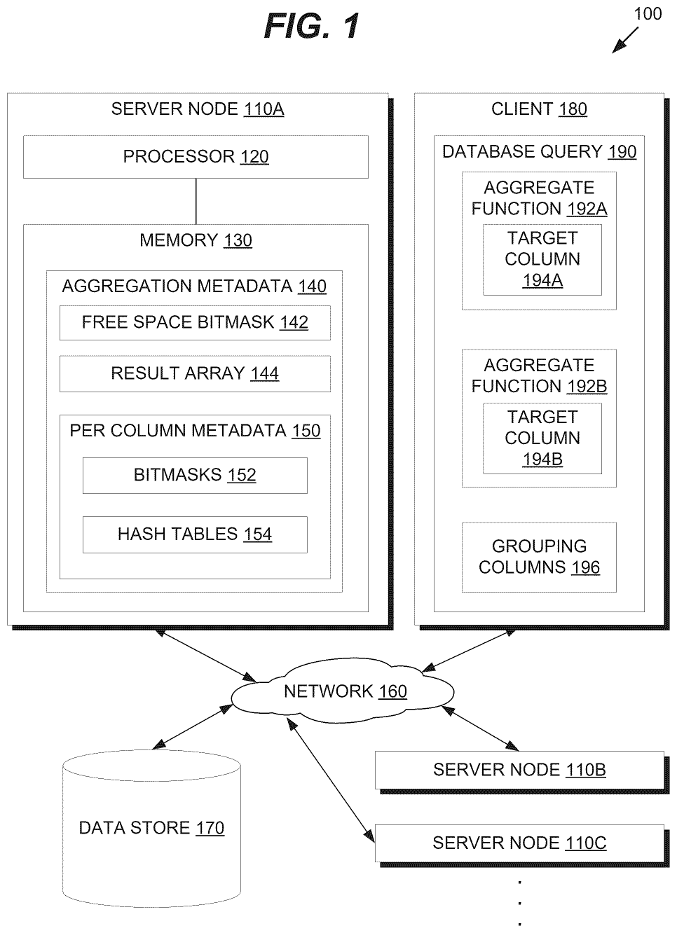

FIG. 1 is a block diagram that depicts an example database management system (DBMS) 100 in which a unique extendable group identifier for efficient aggregation query processing using multiple grouping keys may be supported. DBMS 100 includes server node 110A, server node 110B, server node 110C, network 160, data store 170, and client 180. Server node 110A includes processor 120 and memory 130. Memory 130 includes aggregation metadata 140. Aggregation metadata 140 includes free space bitmask 142, result array 144, and per column metadata 150. Per column metadata 150 includes bitmasks 152 and hash tables 154. Client 180 includes database query 190. Database query 190 includes aggregate function 192A, aggregate function 192B, and grouping columns 196. Aggregate function 192A includes target column 194A. Aggregate function 192B includes target column 194B.

Nodes 110A-110C maintain access to and manage data in a database, such as on data store 170. Each of nodes 110A-110C may be one or more of a rack server such as a blade, a personal computer, a mainframe, a virtual computer, or other computing device. Additional nodes may also be present that are not specifically shown. Further, nodes 110B and 110C may contain similar elements as node 110A, but the elements are omitted for illustrative purposes.

According to one or more embodiments, access to a given database comprises access to (a) a set of disk drives storing data for the database, and (b) data blocks stored thereon. The database may reside in any type of data store 170, including volatile and non-volatile storage, e.g., random access memory (RAM), one or more hard disks, main memory, etc.

Client 180 may be implemented by any type of computing device that is communicatively connected to network 160. In DBMS 100, client 180 is configured with a database client, which may be implemented in any number of ways, including as a stand-alone application running on client 180, or as a plugin to a browser running at client 180, etc. Client 180 may submit one or more database queries, including database query 190, to be serviced by one or more server nodes 110A-110C. Client 180 may be configured with other mechanisms, processes and functionalities, depending upon a particular implementation.

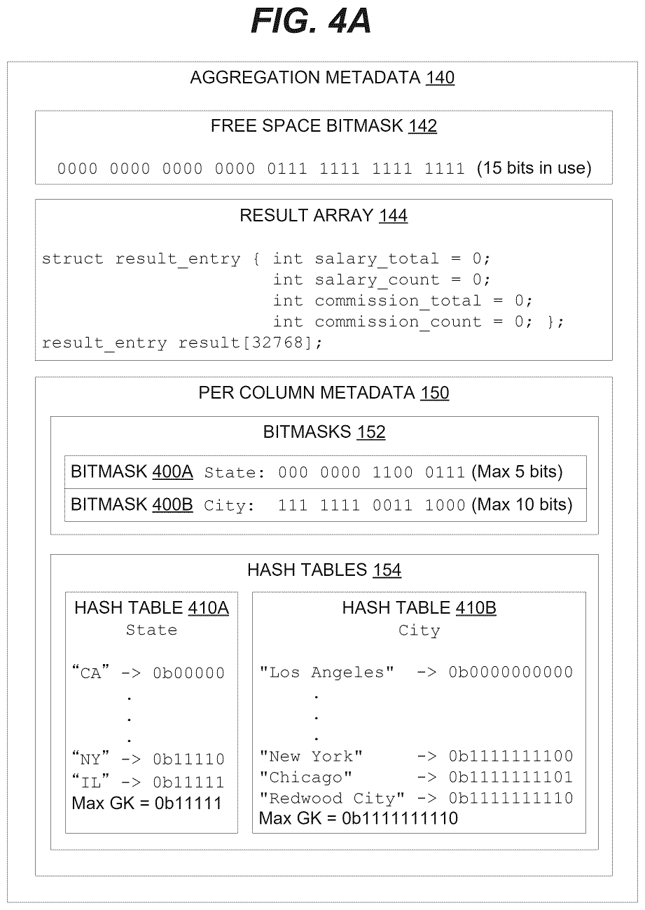

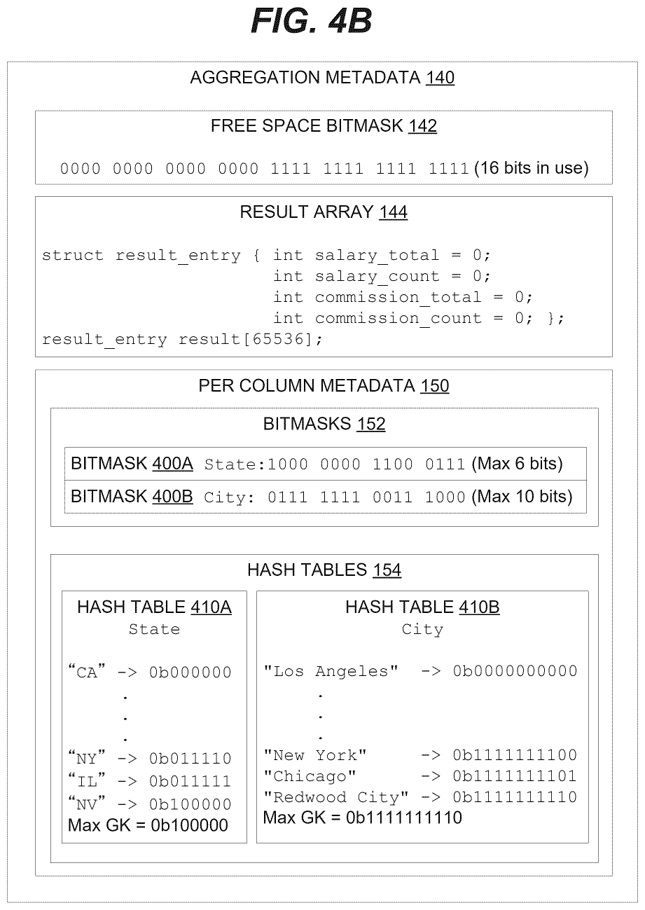

During the process of performing an execution plan for database query 190, server node 110A may perform aggregate function 192A on target column 194A and aggregate function 192B on target column 194B of a database table in data store 170, organized by grouping columns 196. To assist in the aggregation, server node 110A may generate and maintain aggregation metadata 140 to support a unique extendable group identifier that enables indexing directly into result array 144. Free space bitmask 142 defines the largest possible value for the unique extendable group identifier, bitmasks 152 define bit positions of grouping keys for each of grouping columns 196 within the unique extendable group identifier, hash tables 154 map field values of each of grouping columns 196 to respective grouping keys, and result array 144 contains the aggregation results. Examples of aggregation metadata 140 are provided in conjunction with FIG. 4A and FIG. 4B below.

### Example Database Table

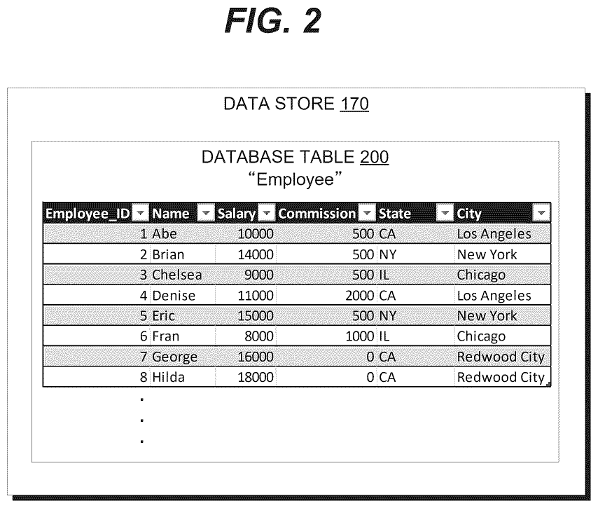

FIG. 2 depicts an example database table 200. Database table 200 may be stored in data store 170. As shown in FIG. 2, database table 200 is named “Employee” and includes columns “Employee_ID”, “Name”, “Salary”, “Commission”, “State”, and “City”. Database table 200 may include a large number of records, but for the purpose of illustration, only eight example rows are shown in FIG. 2.

### Example Database Query with Aggregation

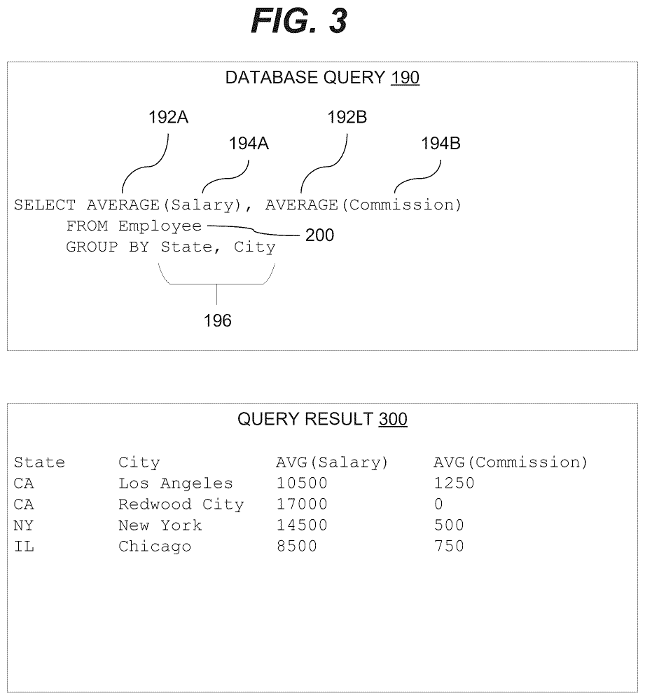

FIG. 3 depicts an example database query 190 with an aggregate function 192A (AVERAGE) on target column 194A (Salary) of database table 200 (Employee) using multiple grouping columns 196 (State, City), and a corresponding query result 300. During query processing, field data in database table 200 within each column of grouping columns 196 may be mapped into corresponding grouping keys via separate hash tables. As shown in FIG. 3, database query 190 may potentially include multiple aggregate functions, as indicated by the second aggregate function 192B (AVERAGE) on target column 194B (Commission). Query result 300 shows the expected results of database query 190 using the 8 example rows of data from database table 200 in FIG. 2. As shown in query result 300, the average Employee Salary and Commission is calculated according to State and City.

The example query shown in database query 190 operates on a single database table 200 stored in data store 170. Thus, the cardinality of the grouping columns of database table 200 can be calculated in advance to size aggregation metadata 140 accordingly. However, more complex database queries may perform aggregation on the result of various database operations such as joined tables, union tables, tables generated by triggers or scripts, imported tables, or other dynamically generated database tables. In this case, the cardinality of the grouping columns in the dynamically generated database table is unknown until the rows are known. Further, in some cases, the cardinality of the grouping columns in the database table may grow during the execution of the database query. For example, additional rows may be added to the database table while the query execution plan is in-flight. Aggregation metadata 140 can accommodate this unknown and potentially growing grouping column cardinality by adding bits to free space bitmask 142 and bitmasks 152, thereby extending the size of the unique extendable group identifier. Further, since extension happens by adding to the most significant bit, existing mappings in hash tables 154 using the less significant bits still remain valid after the extension, thereby avoiding expensive remapping operations.

### Aggregation Metadata

FIG. 4A depicts example aggregation metadata 140 for supporting a unique extendable group identifier for efficient aggregation query processing using multiple grouping keys. Bitmasks 152 includes bitmask 400A and bitmask 400B. Hash tables 154 includes hash table 410A and hash table 410B.

Free space bitmask 142 indicates how many bits are currently used by the unique extendable group identifier, and how many free bits are available for extending. In the example shown in FIG. 4A, 15 bits are currently used, which accommodates 2\hat{ }15 or 32768 group identifier values. In some implementations, free space bitmask 142 may instead be an integer that indicates a number of bits used. In the example shown in FIG. 4A, free space bitmask 142 can be extended up to a maximum of 32 bits. Since result array 144 is sized according to free space bitmask 142, an upper bound may be set according to a projected free space capacity of memory 130 and to avoid free space exhaustion for typical database workloads. Since even large data sets do not often exceed a grouping column cardinality of a million (19 bits), free space exhaustion should not pose a significant concern for most workloads.

Result array 144 is allocated to store the aggregation results. In some implementations, result array 144 may be a segmented array. As shown in FIG. 4A, the result array 144 is sized according to free space bitmask 142 by including 2\hat{ }15, or 32768 entries. Since target column 194A and 194B correspond to “Salary” and “Commission” respectively, the structure of each result entry includes a total and a count for both columns, as shown. Once the final totals and counts are determined, then the averages can be readily determined by dividing the totals by the counts.

Per column metadata 150 contains metadata for each of grouping columns 196, or “State” and “City” in the example database query 190 shown in FIG. 3. Bitmask 400A and 400B define the bit positions for the column grouping keys in the unique extendable group identifier, which is also used as a direct index into result array 144. Thus, bitmask 400A defines the bit positions for the “State” column grouping key in the identifier, up to 5 bits, whereas bitmask 400B defines the bit positions for the “City” column grouping key in the identifier, up to 10 bits. Initially, each bitmask may be set with a default minimum number of set bits, such as 1 bit or 3 bits, which is then extendable as needed to accommodate the cardinality of the grouping columns of a database table. When the maximum grouping key for a column exceeds the number of allocated bits in a bitmask, the free space bitmask 142 and the bitmask may be extended by setting bits in the direction of the most significant bit. This process is illustrated in conjunction with FIG. 4B below.

As shown in hash table 410A, a mapping is provided to map keys, or state strings, into a corresponding code, or column grouping key. Thus, “CA” maps to “0b00000” or 0, “NY” maps to “0b11110” or 30, and “IL” maps to “0b11111”, or 31. Since grouping keys are assigned incrementally, hash table 410A may include 32 mappings, but only 3 mappings are shown for clarity. Further, hash table 410A may also track the current maximum grouping key, or “0b11111”=31.

Similarly, hash table 410B maps city strings to column grouping keys, wherein “Los Angeles” maps to “0b0000000000” or 0, “New York” maps to “0b1111111100” or 508, “Chicago” maps to “0b1111111101” or 509, and “Redwood City” maps to “0b1111111110” or 510. Hash table 410B may include 511 mappings, but only 4 are shown for clarity. Further, hash table 410B may also track the current maximum grouping key, or “0b1111111110”=510.

### Extending the Unique Extendible Group Identifier

As discussed above, the unique extendible group identifier can be extended to accommodate the cardinality of the grouping columns of a database table. For example, assume that an additional record is added to database table 200 that includes the state “NV”, which has not yet been encountered in database table 200. This requires a new mapping in hash table 410A, but there are no new grouping keys assignable with only 5 bits assigned to bitmask 400A and the maximum grouping key being “0b11111”, or 31.

Accordingly, referring now to FIG. 4B, bitmask 400A and free space bitmask 142 can both be extended by setting a bit towards the most significant bits. Thus, comparing to FIG. 4A, free space bitmask 142 is changed from “0000 0000 0000 0000 0111 1111 1111 1111 (15 bits in use)” to “0000 0000 0000 0000 1111 1111 1111 1111 (16 bits in use)”, and bitmask 400A is changed from “000 0000 1100 0111 (Max 5 bits)” to “1000 0000 1100 0111 (Max 6 bits)”. Bitmask 400B is also extended with a non-set bit to change from “111 1111 0011 1000 (Max 10 bits)” to “0111 1111 0011 1000 (Max 10 bits)”. As shown in hash table 410A, the existing mappings are still valid, and the new mapping for “NV” to “0b100000” can now be added. Further, result array 144 is extended to accommodate the larger number of aggregation results, from 2\hat{ }15 (32768) to 2\hat{ }16 (65536), as indicated by “result_entry result[65536];”. In this manner, the number of bits used to represent each column grouping key can be adjusted according to the cardinality of the grouping columns of a database table.

### Generating the Unique Extendible Group Identifier

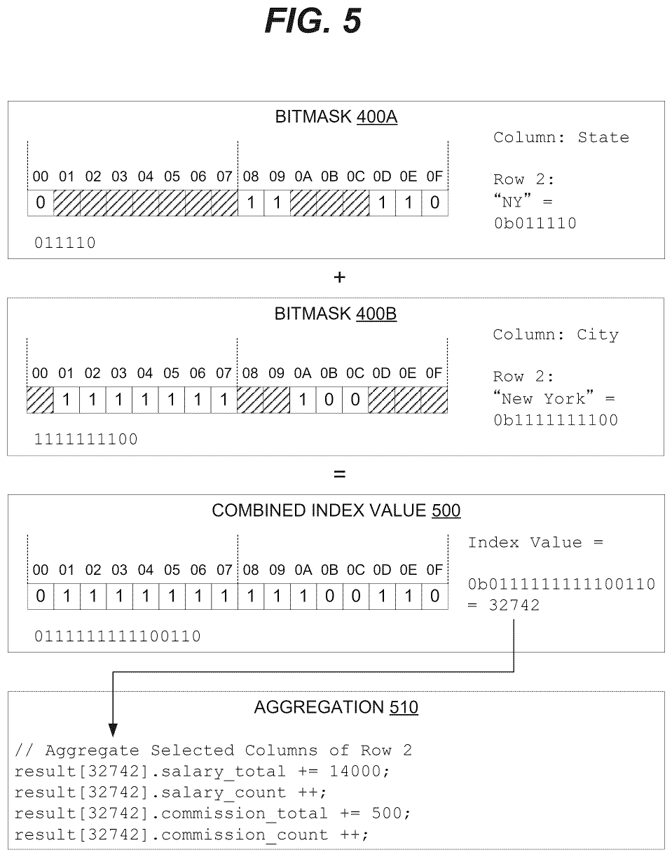

FIG. 5 is a block diagram that depicts generating a combined index value 500 using bitmasks on row data to perform aggregation using multiple grouping keys. For the purposes of illustration, FIG. 5 operates on row 2 of database table 200 in FIG. 2, or for Employee_ID=“2”. As shown in FIG. 5, bitmasks 400B and 400B are used to define the bit positions of the column grouping keys.

For example, referring to bitmask 400A and row 2 of database table 200 in FIG. 2, the “State” field contains the value “NY”. Referring to hash table 410A of FIG. 4B, the corresponding column grouping key is “0b011110”, which is then inserted into the bit positions defined by bitmask 400A. Similarly, referring to bitmask 400B and row 2 of database table 200 in FIG. 2, the “City” field contains the value “New York”. Referring to hash table 410B of FIG. 4B, the corresponding column grouping key is “0b1111111100”, which is then inserted into the bit positions defined by bitmask 400B. By combining the grouping key values inserted into bitmasks 400A and 400B, combined index value 500 can be generated, or “0b0111111111100110”=32742. Combined index value 500 corresponds to the unique extendible group identifier as described above, and can be used as a direct index into result array 144.

As shown in aggregation 510, the aggregation calculation for the “Salary” column can be completed by adding the “Salary” field of row 2, or “14000” to “result[32742].salary_total” and incrementing “result[32742].salary_count”. Similarly, the aggregation calculation for the “Commission” column can be completed by adding the “Commission” field of row 2, or “500” to “result[32742].commission_total” and incrementing “result[32742].commission_count”. Once aggregation 510 is completed for all records in the database table, the averages can be provided by dividing the totals by the respective counts. Further, since aggregation 510 can be performed independently for different array indexes of result array 144, aggregation 510 can be accelerated by coalescing and queuing into multiple threads and/or SIMD instructions on processor 120. The parallelization can also be applied to multiple aggregation operations on the same array index.

### Example Process

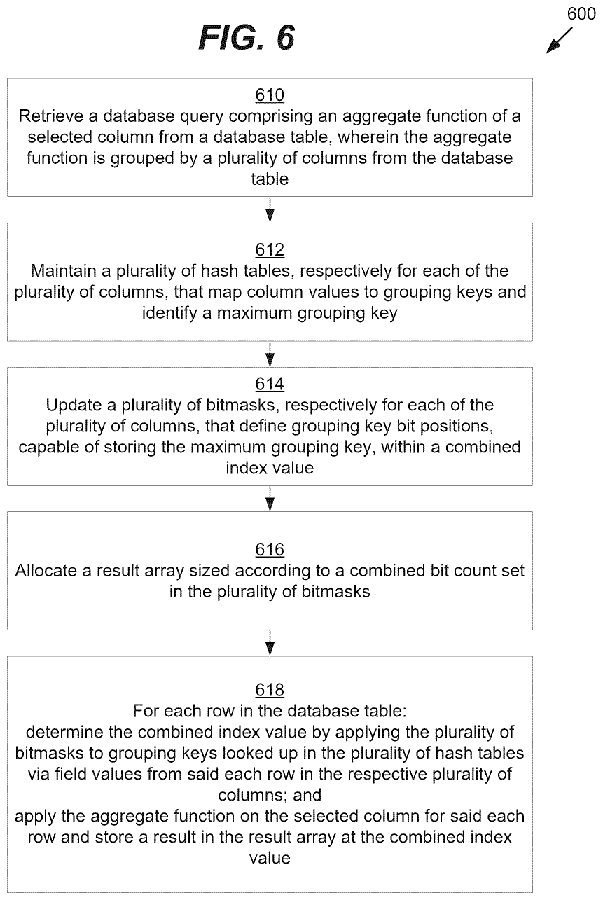

FIG. 6 is a flow diagram that depicts an example process 600 to perform an aggregation query using multiple grouping keys via a unique extendable group identifier.

Referring to FIG. 1 and FIG. 2, in block 610, processor 120 retrieves database query 190 from client 180 via network 160, wherein database query 190 comprises aggregate function 192A of target column 194A from database table 200, and wherein aggregate function 192A is grouped by grouping columns 196. For example, referring to FIG. 3, database query 190 may correspond to the SQL query as shown, wherein aggregate function 192A is “AVERAGE”, target column 194A is “Salary”, database table 200 is “Employee”, and grouping columns 196 include “State” and “City”.

In block 612, referring to FIG. 1 and FIG. 4A, processor 120 maintains hash tables 154, or hash table 410A and 410B, respectively for each of grouping columns 196, that map column values to grouping keys and identify a maximum grouping key. In FIG. 4A, hash table 410A has a maximum grouping key of “0b11111” and hash table 410B has a maximum grouping key of “0b1111111110”.

In block 614, referring to FIG. 1 and FIG. 4A, processor 120 updates bitmasks 152, or bitmask 400A and 400B respectively for each of grouping columns 196, that define grouping key bit positions, capable of storing the maximum grouping keys maintained in block 612, within a combined index value. Bitmasks 152 may be initially set with default bitmasks and may expand as necessary to accommodate the maximum grouping keys, as described above in conjunction with FIG. 4B.

In block 616, referring to FIG. 1 and FIG. 4A, processor 120 allocates result array 144 according to a combined bit count set in bitmasks 152. As shown in FIG. 4A, the combined bit count set in bitmasks 152 is represented by free space bitmask 142, which indicates that 15 bits are in use. Thus, result array 144 is allocated to support 2\hat{ }15 or 32768 entries. When free space bitmask 142 expands, result array 144 also expands to support the larger number of entries, as shown by 2\hat{ }16 or 65536 entries allocated in FIG. 4B. If result array 144 is a segmented array, then additional segments may be added.

In block 618, referring to FIG. 1, FIG. 2, FIG. 4A and FIG. 5, for each row in database table 200, processor 120 determines combined index value 500 by applying bitmasks 400A and 400B to grouping keys looked up in hash tables 410A and 410B via field values from said each row in the respective grouping columns 196. Once combined index value 500 is determined, it can then be used to apply aggregate function 192A on target column 194A, as shown by aggregation 510. For example, the process of block 618 with respect to row 2 is described above in conjunction with FIG. 5, and may be repeated for each row of database table 200. Further, as discussed above, block 618 may be parallelized by coalescing and queuing into multiple threads and/or SIMD operations using different independent indexes of result array 144, and also for multiple aggregations on the same index. After process 600, the aggregation results in response to database query 190 can be provided, as shown by query result 300 of FIG. 3.

### Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, (e.g. Oracle Database 11g). SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

### Query Optimization and Execution Plans

Query optimization generates one or more different candidate execution plans for a query, which are evaluated by the query optimizer to determine which execution plan should be used to compute the query.

Execution plans may be represented by a graph of interlinked nodes, each representing an plan operator or row sources. The hierarchy of the graphs (i.e., directed tree) represents the order in which the execution plan operators are performed and how data flows between each of the execution plan operators.

An operator, as the term is used herein, comprises one or more routines or functions that are configured for performing operations on input rows or tuples to generate an output set of rows or tuples. The operations may use interim data structures. Output set of rows or tuples may be used as input rows or tuples for a parent operator.

An operator may be executed by one or more computer processes or threads. Referring to an operator as performing an operation means that a process or thread executing functions or routines of an operator are performing the operation.

A row source performs operations on input rows and generates output rows, which may serve as input to another row source. The output rows may be new rows, and or a version of the input rows that have been transformed by the row source.

A match operator of a path pattern expression performs operations on a set of input matching vertices and generates a set of output matching vertices, which may serve as input to another match operator in the path pattern expression. The match operator performs logic over multiple vertex/edges to generate the set of output matching vertices for a specific hop of a target pattern corresponding to the path pattern expression.

An execution plan operator generates a set of rows (which may be referred to as a table) as output and execution plan operations include, for example, a table scan, an index scan, sort-merge join, nested-loop join, filter, and importantly, a full outer join.

A query optimizer may optimize a query by transforming the query. In general, transforming a query involves rewriting a query into another semantically equivalent query that should produce the same result and that can potentially be executed more efficiently, i.e. one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

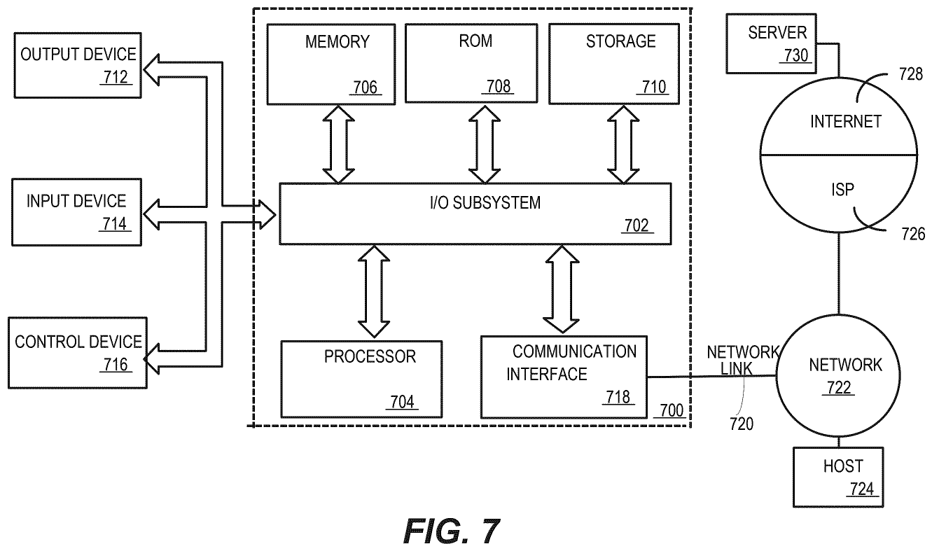

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 1030 might transmit a requested code for an application program through Internet 728, ISP 726, local network 722 and communication interface 718.

The received code may be executed by processor 704 as it is received, and/or stored in storage device 710, or other non-volatile storage for later execution.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

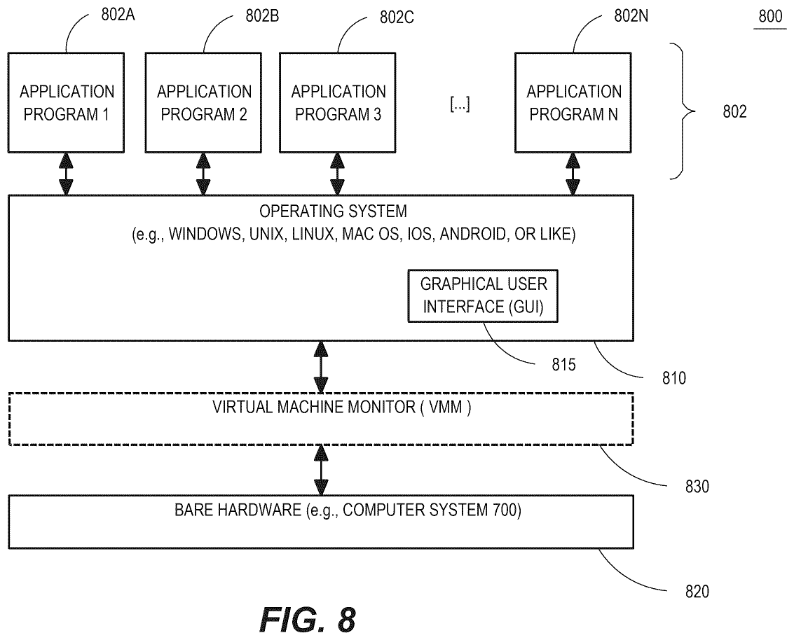

FIG. 8 is a block diagram of a basic software system 800 that may be employed for controlling the operation of computing device 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing device 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on device 800 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of device 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the device 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of device 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### EXTENSIONS AND ALTERNATIVES

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method comprising:
retrieving a database query comprising an aggregate function of a selected column from a database table, wherein the aggregate function is grouped by a plurality of columns from the database table;
maintaining a plurality of hash tables, respectively for each of the plurality of columns, that map column values to grouping keys and identify a maximum grouping key;
updating a plurality of bitmasks, respectively for each of the plurality of columns, that define grouping key bit positions, capable of storing the maximum grouping key, within a combined index value;
allocating a result array sized according to a combined bit count set in the plurality of bitmasks; and
for each row in the database table:
determining the combined index value by applying the plurality of bitmasks to grouping keys looked up in the plurality of hash tables via field values from said each row in the respective plurality of columns; and
applying the aggregate function on the selected column for said each row and storing a result in the result array at the combined index value.

2. The method of claim 1, wherein applying the aggregate function for each row in the database table is performed by parallel threads.

3. The method of claim 1, wherein applying the aggregate function for each row in the database table is performed by coalescing and queuing the aggregate function in parallel for independent indexes of the result array.

4. The method of claim 1, wherein applying the aggregate function utilizes one or more SIMD instructions.

5. The method of claim 1, wherein updating the plurality of bitmasks extends the plurality of bitmasks towards a most significant bit in response to the combined index value being unable to support a cardinality of the plurality of columns of the database table.

6. The method of claim 1, wherein at least one of the plurality of columns from the database table is dictionary compressed, and wherein decompressing the at least one of the plurality of columns is omitted when maintaining the plurality of hash tables.

7. The method of claim 1, wherein the aggregate function comprises one of: sum, count, minimum, maximum, or average.

8. The method of claim 1, wherein the database table is generated by a join operation on a plurality of database tables.

9. The method of claim 1, wherein the plurality of bitmasks is configured with an initial default number of set bits.

10. The method of claim 1, wherein the combined bit count set in the plurality of bitmasks is configured not to exceed an upper bound.

11. One or more non-transitory computer-readable media storing instructions that, when executed by one or more processors, cause:
retrieving a database query comprising an aggregate function of a selected column from a database table, wherein the aggregate function is grouped by a plurality of columns from the database table;
maintaining a plurality of hash tables, respectively for each of the plurality of columns, that map column values to grouping keys and identify a maximum grouping key;
updating a plurality of bitmasks, respectively for each of the plurality of columns, that define grouping key bit positions, capable of storing the maximum grouping key, within a combined index value;
allocating a result array sized according to a combined bit count set in the plurality of bitmasks; and
for each row in the database table:
determining the combined index value by applying the plurality of bitmasks to grouping keys looked up in the plurality of hash tables via field values from said each row in the respective plurality of columns; and
applying the aggregate function on the selected column for said each row and storing a result in the result array at the combined index value.

12. The one or more non-transitory computer-readable media of claim 11, wherein applying the aggregate function for each row in the database table is performed by parallel threads.

13. The one or more non-transitory computer-readable media of claim 11, wherein applying the aggregate function for each row in the database table is performed by coalescing and queuing the aggregate function in parallel for independent indexes of the result array.

14. The one or more non-transitory computer-readable media of claim 11, wherein applying the aggregate function utilizes one or more SIMD instructions.

15. The one or more non-transitory computer-readable media of claim 11, wherein updating the plurality of bitmasks extends the plurality of bitmasks towards a most significant bit in response to the combined index value being unable to support a cardinality of the plurality of columns of the database table.

16. The one or more non-transitory computer-readable media of claim 11, wherein at least one of the plurality of columns from the database table is dictionary compressed, and wherein decompressing the at least one of the plurality of columns is omitted when maintaining the plurality of hash tables.

17. The one or more non-transitory computer-readable media of claim 11, wherein the aggregate function comprises one of: sum, count, minimum, maximum, or average.

18. The one or more non-transitory computer-readable media of claim 11, wherein the database table is generated by a join operation on a plurality of database tables.

19. The one or more non-transitory computer-readable media of claim 11, wherein the plurality of bitmasks is configured with an initial default number of set bits.

20. The one or more non-transitory computer-readable media of claim 11, wherein the combined bit count set in the plurality of bitmasks is configured not to exceed an upper bound.
